(19) United States
(12) Patent Application Publication
(10) Pub. No.: US 2004/0176522 A1
(43) Pub. Date: Sep. 9, 2004

(54) Adhesives/sealants with high electrical resistance

(76) Inventors: Michael Schaetzle, Walldorf (DE); Gabriele Bride, Nussloch (DE); Wolfgang Goldberger, Helmstadt-Bargen (DE); Horst Beck, Dudenhofen (DE)

Correspondence Address: Stephen D. Harper, Law Department, Henkel Corporation, 2200 Renaissance Blvd., Suite 200, Gulph Mills, PA, 19406, US

(21) Appl. No.: 10/739,390

(22) Filed: Dec. 18, 2003

Related U.S. Application Data
(63) Continuation of application No. PCT/EP02/06769, filed on Jun. 19, 2002.

(30) Foreign Application Priority Data
Jun. 27, 2001 (DE) 101 30 889.2

(51) Int. Cl. C08K 3/04; B60J 1/00

(52) U.S. Cl. 524/495; 156/108

(57) ABSTRACT

Solutions of non-functional thermoplastic polymers in preferably high-boiling dissolving agents/plasticizers are suitable as additive additions in high-strength adhesives/sealant comprising high percentages of carbon black as a reinforcing filler for windscreen glazing in automobile construction for increasing the electrical resistance and thus for improving the electrical properties of antennae integrated into the vehicle windscreens.

This application is a continuation under 35 USC Sections 365 (c) and 120 of International Application No. PCT/EP02/06769, filed 19 Jun. 2002 and published 9 Jan. 2003 as WO 03/002683, which claims priority from German Application No. 10130889.2, filed 27 Jun. 2001, each of which is incorporated herein by reference in its entirety.

### BACKGROUND OF THE INVENTION

1. Field of the Invention

The present invention relates to one- or two-component adhesives/sealants with a high electrical resistance and to special additives for increasing the electrical resistance of the adhesives/sealants.

2. Discussion of the Related Art

Elastomeric adhesives/sealants have for years played an important role in numerous technical applications. Due to their high elasticity, combined with excellent tensile and tear strength, a broad adhesion spectrum with and without primer and their favorable price/performance ratio, they are particularly suitable for applications in the automobile industry. For example, one-component moisture-curing polyurethane adhesives/sealants are employed for the most diverse sealing and gluing problems where a high tensile and tear strength is important. In their one-component, moisture-curing embodiment, these compositions comprise a binder with free reactive isocyanate groups. In the absence of moisture, these systems are stable to storage over long periods of time in a paste-like, sometimes very highly viscous form, and when moisture from the surrounding air has access to them after application and joining of the components to be bonded, the water reacts with the isocyanate groups in a known manner and in the end leads to a high-strength elastomeric bond between the workpieces by crosslinking. In the two-component embodiment, one component comprises a similar binder with reactive isocyanate groups and the second component comprises a binder with active hydrogen, this usually being polyols, polyamines or also water in a paste-like matrix or in the form of substances which donate water, such as water-charged molecular sieves, inorganic or organic compounds containing water of crystallization and the like. One- or two-component binder systems which are free from isocyanate groups have also been proposed for adhesive/sealant applications, and these then comprise reactive silane groups, such as e.g. alkoxysilanes, acetoxysilanes, silazanes or oximatosilanes, instead of the reactive isocyanate groups.

In addition to the abovementioned binders, the one- or two-component reactive adhesive/sealant compositions also comprise plasticizers, fillers, catalysts, optionally pigments, adhesion-promoting substances, stabilizers to increase the storage stability and as anti-ageing agents, auxiliary substances for influencing the rheology and further auxiliary substances and additives.

An important field of use for such adhesives/sealants in the vehicle industry, in particular in the production of automobiles, is direct glazing of vehicle windscreens. Paste-like, highly viscous adhesives/sealants are employed for these applications, and in the auto industry as a rule are applied to the vehicle body flange or the glass windscreen. by robots, it being possible for the adhesive/ sealant optionally to be heated slightly for easier application. The technical demands on adhesives for gluing windscreens in the automobile industry have risen constantly. In the original concept of automobile construction, such adhesives were used exclusively. to join the windscreen into the vehicle body such that moisture and dust from the outside cannot penetrate into the interior of the vehicle body, and furthermore the windscreen should be joined into the vehicle body in a crash-stable manner, i.e., in the event of an accident the windscreen should remain firmly bonded to the vehicle body and not fall out. On the one hand passers-by should not be endangered by windscreens flying around, and on the other hand it must be possible for the now conventional airbags to be supported on the windscreen in order to keep the risk of injury to the vehicle occupants as low as possible.

In modern vehicle construction the function of this gluing has been extended to the extent that it has been possible to improve the torsional rigidity of the vehicle body and rolling strength using high-strength and high-modulus adhesives such that thicker and therefore heavier metal sheets do not have to be incorporated into the construction of the vehicle body. For this reason modern windscreen adhesives must be highly elastic, but they must nevertheless have a high shear modulus and high tensile and tear strength. Such high mechanical properties can be achieved only by co-using reinforcing fillers. The various carbon blacks, optionally in combination with other inorganic and organic fillers, are known high-performance and inexpensive fillers which guarantees these reinforcing properties to a high degree. In addition to the good reinforcing action in the binder matrix, most carbon blacks also have some further favorable properties, and the flow properties of the paste-like adhesive/sealant which has not yet cured can be influenced in a positive manner by suitable carbon blacks, so that the adhesive/sealant can be extruded with shaping on to the substrate from application devices without applying too high a pressure, but after the extrusion remains dimensionally stable on the substrate and in the non-cured state is nevertheless still plastically deformable. The carbon black in the cured binder matrix furthermore protects the polymers against oxidative or photooxidative degradation. However, a disadvantage of the use of relatively large amounts of carbon black is the deterioration in the electrical properties of the adhesive/sealant such that the electrical resistance of the cured adhesive/sealant is lowered significantly by the high carbon black content. The electrical properties of the adhesive/sealant indeed are not directly related to the abovementioned positive mechanical properties of the adhesive bond, but two aspects in the construction of newer vehicle types change the importance of the electrical properties of the adhesive:

Ever more complex antenna constructions are being integrated into the front and rear screens of vehicles, especially cars. However, the direct voltage properties and the alternating voltage properties of the adhesive/sealant have decisive effects on fault-free functioning of these antennae. An interfering influence on the receiving and emitting properties of the antennae by the adhesive/sealant should be avoided or certainly at least severely suppressed in a wide frequency range (up to into the gigahertz range).

Lightweight construction materials, in particular aluminum are increasingly being used in vehicle body construction. In the electrochemical potential series, carbon black (elemental carbon) is classified as highly positive, i.e. noble. Modern lightweight construction materials based on aluminum and magnesium and alloys thereof, however, are to be found in the negative region of the electrochemical potential series, i.e., they are base with respect to carbon. It is known that when a base element and a noble element come together in the presence of an electrolyte which conducts electrical current (e.g., rain water), the chemically baser material is corroded at the contact point to a considerably higher degree than would be the case without this contact. As is known, contact corrosion is referred to here. In this case the baser substrate, i.e., the aluminum- or magnesium-containing component, would be consumed as the “sacrificial anode” and severely corroded. This contact corrosion and suppression thereof is of importance in practice primarily for the gluing of windscreens in aluminum vehicle bodies.

This problem has hitherto be solved only to a very unsatisfactory degree in that there has been a changeover to drastically lowering the carbon black content in the adhesive/sealant formulations and employing other fillers instead. As a general rule, however, the price paid for this is a number of disadvantages; on the one hand the electrical conductivity does not fall to the extent (several orders of magnitude) actually necessary for the required electrical or electromagnetic properties in respect of antenna suitability, and on the other hand the mechanical properties of the cured adhesive/sealant and the flow properties of the non-cured material often deteriorate (e.g., tendency to draw threads or poorer dimensional stability of the paste-like worm). A higher content of the more expensive binder is moreover often necessary in order to meet the mechanical strengths and the adhesion properties at least to some degree. Attempts have also been made to add to the adhesive formulations contents of PVC polymers in powder form as a filler in order to be able to reduce the carbon black content. However, it is reported that the direct current properties, such as specific resistance, usually remain unchanged by this measure, and at best there is a tendency for them to be improved. In the higher frequency range, however, there are significant and relevant deteriorations in the properties which are attributed to the dipolar character of the PVC molecule, in this context see D. Symietz, D. Jovanovic, “Elektrische Materialkennwerte von Direktverglasungsklebstoffen und ihre praktische Bedeutung [Electrical characteristic material values of direct glazing adhesives and their importance in practice]”, 15th International

Symposium Swiss Bonding 01, 15.-17.05.2001, Rapperswil, Switzerland.

Direct glazing adhesives/sealants which are suitable for gluing vehicle windscreens have been described in a large number of patent applications, and examples which may be mentioned are EPA-264675, EP-A-255572, EP-A-310704, EP-A-439040, EP-A-477060, EP-A-540950 or EP-A-705290. The problem described above of unsatisfactory electrical properties of such adhesives/sealants for direct glazing in automobile construction is not addressed in any of the abovementioned specifications, nor is a solution for this problem provided.

### BRIEF SUMMARY OF THE INVENTION

In view of this prior art, the inventors had the object of discovering ways of increasing the electrical resistance of adhesives/sealants and of providing compositions which allow carbon black to be able to continue to be employed as a reinforcing filler in the amounts required for the mechanical properties.

The present invention comprises providing additives for increasing the electrical resistance of one- or two-component adhesives/sealants.

The present invention also provides a process for the preparation of one- or two-component adhesive/sealant compositions with a high electrical resistance, comprising the following process steps:

a) dispersing a pulverulent thermoplastic polymer in a dissolving agent, preferably a high-boiling solvent or plasticizer;

b) dissolving the polymer, optionally with stirring and heating to temperatures of up to 140° C., until homogeneity is achieved;

c) cooling the polymer solution; and

d) dispersing the polymer solution in an adhesive/sealant composition comprising at least one reactive prepolymer, carbon black, optionally further fillers, plasticizers and optionally catalyst(s) and further auxiliary substances and additives.

### DETAILED DESCRIPTION OF CERTAIN EMBODIMENTS OF THE INVENTION

A large number of thermoplastic polymers, preferably in the form of finely divided powders, are suitable as pulverulent thermoplastic polymers for the preparation of the additive solution. Important selection criteria for the thermoplastic polymers are

No groups which are reactive towards the binder should be present in a significant amount in these thermoplastics, and in particular no noticeable amounts of hydroxyl groups or amino groups should be present in polyurethane systems, since this would lead to a lack of storage stability of the adhesive/sealant compositions.

The polymer powder should dissolve as readily as possible in the high-boiling dissolving agent, optionally with heating to temperatures of up to 140° C.

Concrete examples of suitable polymer powders are polyvinyl chloride (PVC), PVC copolymers (preferably vinyl chloride/vinyl acetate copolymers), ethylene-vinyl acetate (EVA), (meth)acrylic acid esters—practically all the commercially available polymers and copolymers of C₁- to C₁₆-alkyl esters of acrylic acid or methacrylic acid are suitable here, atactic or isotactic poly-α-olefins, polycarbonates, polyesters, styrene homo- or copolymers and mixtures thereof. Phenolic resins can also be employed in two-component binder systems, and in these they are preferably. employed in the hardener component, i.e., the component which does not contain isocyanate, in order to avoid storage stability problems.

Dissolving agents for the abovementioned thermoplastic polymers in the context of this invention are liquids with an adequate dissolving power for the abovementioned polymers, so that at polymer to dissolving agent ratios of 2:1 to 1:5 an adequate homogeneity and solution is achieved, it being possible for the solution optionally to have a gel-like structure at room temperature. If there is sufficient free space in the recipe for larger amounts of dissolving agent/plasticizer, low concentrations of the polymer in the dissolving agent can also be used. It is merely necessary then for a larger amount of this solution to be employed. At high concentrations of the polymer in the dissolving agent the solutions are in some cases in the form of highly viscous gels, and for this reason the concentration is preferably chosen to be as low as possible for easier intermixing. The optimum amount usually results from the amount of dissolving agent/plasticizer available in the recipe. Those solvents which have a boiling point of at least 180° C. under 10 mbar are regarded as high-boiling in the context of the invention. Concrete examples of such high-boiling dissolving agents are the dialkyl phthalates, dialkyl adipates, dialkyl sebacates, mono- or dibenzoic acid esters of monofunctional alcohols or diols, alkyl phosphates, aryl phosphates, alkyl aryl phosphates, alkylsulfonic acid phenyl esters and mineral oils (e.g., white oil) or mixtures thereof, these also being employed as plasticizers. If the adhesive/sealant does not have to be free from volatile constituents, it is also possible to use the usual low-boiling organic solvents, such as esters or ketones, as the dissolving agent. Pulverization or fine grinding of the polymers can help to increase the rate of solution of the polymers, which as a rule are solid. If pretreated in this manner, some of these polymers can already be dissolved sufficiently readily at room temperature, so that the desired effect possibly even already occurs during the compounding process, depending on the solution properties, if the thermoplastic powder has merely been ground sufficiently finely (e.g. by cryoscopic grinding processes).

The electrical.direct current resistance can be increased by about 2 to 7 powers of ten, depending on the nature and amount of additive solution added. The high frequency properties also improve significantly. Surprisingly, this also applies to the use of dissolved gel-like PVC polymer, which is surprising in view of the prejudice described above. Without being bound to this theory, it is supposed that the dissolved polymers impart to the adhesive/sealant composition different electrical properties than when the same polymers are present in finely divided powder form as a dispersion in the binder matrix.

Further constituents of the adhesive/sealant compositions according to the invention are constituents which are known per se. The compositions which moisture-cure as one component comprise at least one reactive prepolymer, preferably a polyurethane prepolymer with reactive isocyanate groups, plasticizers and one or more carbon blacks selected from the group consisting of flame blacks, channel blacks, gas blacks or furnace blacks and mixtures thereof. Further fillers, plasticizers or plasticizer mixtures and catalysts, stabilizers and further auxiliary substances and additives can furthermore be co-used. The isocyanate-functional prepolymers can be obtained in a manner known per se by reaction of linear or branched polyols from the group consisting of polyethers, polyesters, polycarbonates, polycaprolactones and polybutadienes with di- or polyfunctional isocyanates.

Suitable polyols are the polyhydroxy compounds which are liquid, vitreously solid/amorphous or crystalline at room temperature and have two or three hydroxyl groups per molecule in the molecular weight range from 400 to 20,000, preferably in the range from 1,000 to 6,000. Examples are di- and/or trifunctional polypropylene glycols, and it is also possible to employ random and/or block copolymers of ethylene oxide and propylene oxide. Another group of polyethers which are preferably employed are the polytetramethylene glycols (poly(oxytetramethylene) glycol, poly-THF), which are prepared e.g. by acid polymerization of tetrahydrofuran, the molecular weight range of the polytetramethylene glycols here being between 600 and 6,000, preferably in the range from 800 to 5,000.

The liquid, vitreously amorphous or crystalline polyesters which can be prepared by condensation of di- or tricarboxylic acids, such as e.g. adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid, dimer fatty acid or mixtures thereof with low molecular weight diols or triols, such as e.g. ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimer fatty alcohol, glycerol, trimethylolpropane or mixtures thereof, are furthermore suitable as polyols.

The polyesters based on ε-caprolactone, also called “polycaprolactones” are another group of polyols to be employed according to the invention.

However, polyester polyols of oleochemical origin can also be used. Such polyester polyols can be prepared, for example, by complete ring-opening of epoxidized triglycerides of an at least partly olefinically unsaturated fatty acid-containing fat mixture with one or more alcohols having 1 to 12 C atoms and subsequent partial transesterification of the triglyceride derivatives to alkyl ester polyols having 1 to 12 C atoms in the alkyl radical. Further suitable polyols are polycarbonate polyols and dimer diols (available from Henkel) and castor oil and its derivatives. The hydroxy-functional polybutadienes such as are obtainable e.g. under the trade name “Poly-bd” can also be employed as polyols for the compositions according to the invention.

It is also possible to co-use a proportion of diols of low molecular weight, and concrete examples of the latter diols are ethylene glycol, 1,2-propanediol, 1,3-propanediol, 2,2-dimethyl-1,3-propanediol, 2-methylpropanediol, 1,6-hexanediol, 2,4,4-trimethylhexane-1,6-diol, 2,2,4-trimethylhexane-1,6-diol, 1,4-cyclohexanedimethanol, diethylene glycol, triethylene glycol, tetraethylene glycol, dipropylene glycol, tripropylene glycol, tetrapropylene glycol, poly(oxytetramethylene) glycol with a molecular weight of up to 650, alkoxylation products of bisphenol A, alkoxylation products of bisphenol F, of the isomeric dihydroxyanthracenes, of the isomeric dihydroxynaphthalenes, of pyrocatechol, of resorcinol or of hydroquinones having up to 8 alkoxy units per aromatic hydroxyl group or mixtures of the abovementioned diols.

Polyisocyanates which can be used are, in particular, all the usual aliphatic, cycloaliphatic or aromatic di- or polyisocyanates. Examples of suitable aromatic diisocyanates are all the isomers of toluylene diisocyanate (TDI), either in the isomerically pure form or as a mixture of several isomers, naphthalene 1,5-diisocyanate (NDI), naphthalene 1,4-diisocyanate (NDI), diphenylmethane 4,4′-diisocyanate (MDI), diphenylmethane 2,4′-diisocyanate and mixtures of 4,4′-diphenylmethane diisocyanate with the 2,4′-isomer, xylylene diisocyanate (XDI), 4,4′-diphenyl-dimethylmethane diisocyanate, di- and tetraalkyl-diphenylmethane diisocyanate, 4,4′-dibenzyl diisocyanate, 1,3-phenylene diisocyanate and 1,4-phenylene diisocyanate. Examples of suitable cycloaliphatic diisocyanates are the hydrogenation products of the abovementioned aromatic dilsocyanates, such as e.g., 4,4′-dicyclohexylmethane diisocyanate (H12MDI), 1-isocyanatomethyl-3-isocyanato-1,5, 5-trimethyl-cyclohexane (isophorone diisocyanate, IPDI), cyclohexane 1,4-diisocyanate, hydrogenated xylylene diisocyanate (H6XDI), 1-methyl-2,4-diisocyanato-cyclohexane, m- or p-tetramethylxylylene diisocyanate (m-TMXDI, p-TMXDI) and dimer fatty acid diisocyanate. Examples of aliphatic diisocyanates are tetramethoxybutane 1,4-diisocyanate, butane 1,4-diisocyanate, hexane 1,6-diisocyanate (HDI), 1,6-diisocyanato-2,2,4-trimethylhexane, 1,6-diisocyanato-2,4,4-trimethylhexane, lysine diisocyanate and 1,12-dodecane diisocyanate (C12DI).

Suitable plasticizers are all the plasticizers known for adhesives/sealants in polyurethane chemistry, and these are, in particular, the dialkyl phthalates, dialkyl adipates, dialkyl sebacates or alkyl aryl. phthalates, the alkyl radical as a rule being a linear or branched radical having four to twelve carbon atoms. Alkyl benzoates and dibenzoates of polyols, such as ethylene glycol, propylene glycol or the lower polyoxypropylene-polyoxyethene compounds are furthermore suitable. Further suitable plasticizers are alkyl phosphates, aryl phosphates or alkyl aryl phosphates and the alkylsulfonic acid esters of phenol.

In addition to the abovementioned carbon blacks as reinforcing fillers, further fillers can also be co-used, and there may be mentioned here in particular chalks, naturally occurring ground or precipitated calcium carbonates, silicates, such as e.g. aluminum silicates or magnesium aluminum silicates, or also talc.

A proportion of lightweight fillers, for example hollow microbeads of plastic, preferably in pre-expanded form, can also be co-used for the preparation of adhesives/sealants of low specific gravity.

Additives for regulating the flow properties can also additionally be added, and there may be mentioned by way of, example urea derivatives, fibrillated or pulped short fibers, pyrogenic silicas and the like.

“Stabilizers” in the context of this invention are to be understood on the one hand as stabilizers which have an effect of stability on the viscosity of the polyurethane prepolymer during preparation, storage or application. Monofunctional carboxylic acid chlorides, monofunctional highly reactive isocyanates and also non-corrosive inorganic acids, e.g., are suitable for this, and there may be mentioned by way of example benzoyl chloride, toluenesulfonyl isocyanate, phosphoric acid or phosphorous acid. Antioxidants, UV stabilizers or hydrolysis stabilizers are furthermore to be understood as stabilizers in the context of this invention. The choice of these stabilizers depends on the one hand on the main components of the composition, and on the other hand on the application conditions and the loads to be expected on the cured product. If the polyurethane prepolymer is built up predominantly from polyether units, antioxidants may chiefly be necessary, optionally in combination with UV stabilizers. Examples of these are the commercially available sterically hindered phenols and/or thioethers and/or substituted benzotriazoles or the sterically hindered amines of the HALS (“hindered amine light stabilizer”) type.

If essential constituents of the polyurethane prepolymer consist of polyester units, hydrolysis stabilizers, e.g., of the carbodiimide type, can be employed.

The compositions according to the invention can optionally additionally comprise catalysts which accelerate the formation of the polyurethane prepolymer during its preparation and/or which accelerate the moisture-crosslinking after application of the adhesive/sealant. Suitable catalysts which can be employed according to the invention are, e.g., the organometallic compounds of tin, iron, titanium or bismuth, such as tin(II) salts of carboxylic acids, e.g. tin(II) acetate, ethylhexoate and diethylhexoate. The dialkyl-tin(IV) carboxylates are another class of compounds. The carboxylic acids have 2, preferably at least 10, in particular 14 to 32 C atoms. Dicarboxylic acids can also be employed. Acids which may be expressly mentioned are: adipic acid, maleic acid, fumaric acid, malonic acid, succinic acid, pimelic acid, terephthalic acid, phenylacetic acid, benzoic acid, acetic acid, propionic acid and 2-ethylhexanoic, caprylic, capric, lauric, myristic, palmitic and stearic acid. Concrete compounds are dibutyl- and dioctyltin-diacetate, maleate, bis-(2-ethylhexoate) and dilaurate, tributyltin acetate, bis(β-methoxycarbonylethyl)tin dilaurate and bis(β-acetyl-ethyl)tin dilaurate.

Tin oxides and sulfides as well as thiolates can also be used. Concrete compounds are: bis(tributyltin) oxide, bis(trioctyltin) oxide, dibutyl- and dioctyltin bis(2-ethyl-hexylthiolate), dibutyl- and dioctyltin didodecylthiolate, bis(β-methoxycarbonyl-ethyl)tin didoceylthiolate, bis(β-acetyl-ethyl)tin bis(2-ethylhexylthiolate), dibutyl- and dioctyltin didodecylthiolate, butyl- and octyltin tris(thioglycollic acid 2-ethylhexoate), dibutyl- and dioctyltin bis(thioglycollic acid 2-ethylhexoate), tributyl- and trioctyltin (thioglycollic acid 2-ethylhexoate) and butyl- and octyltin tris(thioethylene glycol 2-ethylhexoate), dibutyl- and dioctyltin bis(thioethylene glycol 2-ethylhexoate), tributyl- and trioctyltin (thioethylene glycol 2-ethylhexoate) with the general formula Rₙ₊₁Sn (SCH₂CH₂OCOC₈H₁₇)₃₋ₙ, wherein R is an alkyl group having 4 to 8 C atoms, bis(β-methoxycarbonyl-ethyl)tin bis(thioethylene glycol 2-ethylhexoate), bis(β-methoxycarbonyl-ethyl)tin bis(thioglycollic acid 2-ethylhexoate), and bis(β-acetyl-ethyl)tin bis(thioethylene glycol 2-ethylhexoate) and bis(β-acetyl-ethyl)tin bis(thioglycollic acid 2-ethylhexoate).

Aliphatic tertiary amines, in particular with a cyclic structure, are also additionally suitable. Among the tertiary amines, those which additionally also carry groups which are reactive towards the isocyanates, in particular hydroxyl and/or amino groups, are also suitable. There may be mentioned concretely: dimethylmonoethanolamine, diethylmonoethanolamine, methylethylmonoethanolamine, triethanolamine, trimethanolamine, tripropanolamine, tributanolamine, trihexanolamine, tripentanolamine, tricyclohexanolamine, diethanolmethylamine, diethanolethylamine, diethanolpropylamine, diethanolbutylamine, diethanolpentylamine, diethanolhexylamine, diethanolcyclohexylamine, diethanolphenylamine and ethoxylation and propoxylation products thereof, diazabicyclooctane (DABCO), triethylamine, dimethylbenzylamine (DESMORAPID DB, BAYER), bis-dimethylaminoethyl ether (Catalyst A 1, UCC), tetramethylguanidine, bis-dimethylaminomethylphenol, 2-(2-dimethylaminoethoxy) ethanol, 2-dimethylaminoethyl 3-dimethylaminopropyl ether, bis(2-dimethylaminoethyl) ether, N,N-dimethylpiperazine, N- (2-hydroxyethoxyethyl) -2-azanorbornanes, or also unsaturated bicyclic amines, e.g. diazabicycloundecene (DBU) and TEXACAT DP-914 (Texaco Chemical), N,N,N,N-tetramethylbutane-1,3-diamine, N,N,N,N-tetramethylpropane-1,3-diamine and N,N,N,N-tetramethylhexane-1,6-diamine. The catalysts can also be in oligomerized or polymerized form, e.g. as N-methylated polyethyleneimine.

However, the derivatives of morpholine are very particularly preferred catalysts. Concrete examples of suitable morpholino compounds are bis(2-(2,6-dimethyl-4-morpholino)ethyl)-(2-(4-morpholino)ethyl)amine, bis(2-(2,6-dimethyl-4-morpholino)ethyl)-(2-(2,6-diethyl-4-morpholino)ethyl)amine, tris(2-(4-morpholino)ethyl)amine, tris(2-(4-morpholino)propyl)amine, tris(2-(4-morpholino)butyl)amine, tris(2-(2,6-dimethyl-4-morpholino)ethyl)amine, tris(2-(2,6-diethyl-4-morpholino)ethyl)amine, tris(2-(2-methyl-4-morpholino)ethyl)amine or tris(2-(2-ethyl-4-morpholino) ethyl)amine, dimethylaminopropylmorpholine, bis(morpholinopropyl)-methylamine, diethylaminopropylmorpholine, bis (morpholinopropyl) ethylamine, bis(morpholinopropyl)propylamine, morpholinopropylpyrrolidone or N-morpholinopropyl-N′-methyl-piperazine, dimorpholinodiethyl ether (DMDEE) or di-2,6-dimethylmorpholinoethyl) ether.

The abovementioned morpholine derivatives have a particularly high catalytic activity, in particular of the water (moisture) isocyanate reaction. Very low catalyst concentrations are therefore already highly efficient for crosslinking or curing of the adhesives, and the concentrations of the catalyst in the adhesive formulation can be between 0.001 and 2 wt. %, preferably between 0.02 and 0.9 wt. %.

For high-strength and high-modulus adhesives, a high content of carbon black is as a rule co-used as a reinforcing filler, and the content of carbon black is preferably above 10 wt. %, based on the total adhesive composition, and is typically between 15 and 25 wt. %, and can be up to 40 wt. %.

Inorganic fillers, such as chalks, are typically present in the formulations in the order of between 5 and 25 wt. %. In the case of one-component compositions, the prepolymer content is of the order of 20 to 50 wt. %, where the prepolymer can often comprise up to 20 wt. % of plasticizers for handling reasons.

The additive solution according to the invention of thermoplastic polymer and high-boiling dissolving agent is usually prepared in a ratio of polymer to dissolving agent of 2:1 to 1:50. 2 to 25 wt. % of the abovementioned solution are added to the adhesive composition, depending on the desired electrical resistance, which corresponds to a total content of thermoplastic polymer (ignoring the dissolving agent content) of 1.5 wt. % up to 7 wt. %.

The specific direct current resistance can be improved from approx. 10⁵Ω.cm to 10⁹ to 10¹⁰Ω.cm by these additives, and this value is frequently specified by the auto industry for “antenna suitable” gluings. If required, this value can be increased to 10¹² to 10¹⁴Ω.cm by higher amounts of dissolved thermoplastic. At the same time the alternating current values improve, and the capacitance values are in the range of the requirements of modern windscreen adhesives with antenna suitability, in spite of a high carbon black content. It has furthermore been found that the electrical properties of an adhesive according to the invention even improve over the storage period.

Furthermore, for antenna suitability automobile manufacturers often require that the impedance does not exceed the following values: at frequencies below 6 MHz ε′≦25 and ε″≦1.8 and at 100 MHz ε′10±5 and ε″1.5±0.5. These measurements are made with a commercially available RF impedance analyzer.

The following examples are intended to give a more detailed explanation of the invention and are given merely by way of example and do not cover the entire range of adhesive/sealant compositions according to the invention. However, the expert can easily deduce the entire range of use from the statements made above.

### EXAMPLES

### Example 1

The direct glazing adhesive/sealant “TEROSTAT 8599” (Henkel Teroson GmbH) has a carbon black content of about 18.5 wt. %, and a specific electrical resistance of about 10⁵Ω.cm is measured on this adhesive/sealant.

### Example 2 (According to the Invention)

One part of a phthalic acid/fumaric acid diol polyester, melting point 100° C., acid number 15.5, OH number 20 mg KOH/g was dispersed in two parts of dipropylene glycol dibenzoate, with gentle stirring, and then dissolved by heating to 120° C. The clear solution was cooled to room temperature. The commercially available direct glazing adhesive TEROSTAT 8599 (Henkel Teroson) was initially introduced into a planetary mixer and 7.5 wt. % of the abovementioned polyester resin solution in the benzoic acid ester was added to this, while stirring. The direct current resistance of this product was measured, and had risen to 10¹⁰Ω.cm, i.e. by 5 powers of ten with respect to the non-modified adhesive/sealant. Comparison samples in which 7.5 wt. % of plasticizer or prepolymer was added to the TEROSTAT 8599 showed, in contrast, only an insignificant increase in the electrical resistance, and when the abovementioned polyester resin was added in solid form to the adhesive, the electrical resistance also scarcely increased. This shows that only the addition according to the invention of the polyester resin in solution has the effect of a significant increase in the direct current resistance by several powers of ten.

### Example 3

In an analogous manner, 6 wt. % of the polyester resin/benzoic acid ester solution (ratio 1:1) was added to the commercially available direct glazing adhesive/sealant TEROSTAT 8597 (Henkel Teroson GmbH). In this case also, the direct current resistance. rose to 10¹⁰Ω.cm, compared with a direct current resistance of the non-modified adhesive/sealant of 10⁵Ω.cm.

In all the adhesives/sealants modified according to the invention, in addition to very good direct current resistances very good alternating current properties were also measured, so that these adhesives are suitable for gluing windscreens with highly integrated antennae or also for applications on baser metals (such as, e.g., aluminum).

Additions of 6 to 9 wt. % of solutions of polystyrene, ABS resins or phenolic resins in plasticizers, isoparaffins or ethyl acetate to the commercially available direct glazing adhesive/sealant TEROSTAT 8598 (Henkel Teroson GmbH) also led to an increase in the direct current resistance from originally 10⁵Ω.cm to 10⁹ to >10¹⁰Ω.cm.

What is claimed is:

1. A one- or two-component reactive adhesive/sealant composition comprising a reactive binder, more than 10 wt. % of the total composition of carbon black as a reinforcing filler and a solution of at least one non-functional thermoplastic polymer in at least one dissolving agent.

2. A one-component reactive adhesive/sealant composition according to claim 1, wherein the reactive binder comprises a prepolymer with reactive isocyanate groups or reactive silane groups selected from the group consisting of alkoxysilanes, acetoxysilanes, silazanes, oximatosilanes, and combinations thereof.

3. A two-component reactive adhesive/sealant composition according to claim 1 comprising a first component and a second component, wherein the first component comprises a reactive binder comprising a prepolymer with reactive isocyanate groups or reactive silane groups selected from the group consisting of alkoxysilanes, acetoxysilanes, silazanes, oximatosilanes, and combinations thereof and the second component is a hardener component which comprises one or more polyhydroxy compounds, polyamines or mixtures thereof.

4. A one- or two-component adhesive/sealant composition according to claim 1, wherein at least one non-functional polymer is selected from the group consisting of vinyl chloride homo- and copolymers, ethylene-vinyl acetate copolymers, (meth)acrylic acid ester homo- and copolymers, atactic and isotactic poly-α-olefins, polycarbonates, polyesters, phenolic resins, styrene homo- and copolymers and mixtures thereof.

5. A one- or two-component adhesive/sealant composition according to claim 1, wherein at least one dissolving agent is a high-boiling dissolving agent.

6. A one- or two-component adhesive/sealant composition according to claim 1, wherein at least one dissolving agent is selected from the group consisting of ethyl acetate, isoparaffins, dialkyl phthalates, dialkyl adipates, dialkyl sebacates, alkyl, aryl and alkyl aryl phosphates, alkylsulfonic acid phenyl esters, mineral oil and mixtures thereof.

7. A composition according to claim 1 comprising 1 to 10 wt. % of non-functional thermoplastic polymer.

8. A composition according to claim 1 comprising 1.5 to 7 wt. % of non-functional thermoplastic polymer.

9. A composition according to claim 1 comprising 15 to 25 wt. % carbon black.

10. A composition according to claim 1 wherein the ratio of non-functional thermoplastic polymer to dissolving agent is from 2:1 to 1:50.

11. A composition according to claim 1 wherein the ratio of non-functional thermoplastic polymer to dissolving agent is from 2:1 to 1:5.

12. A composition according to claim 1 wherein said solution comprises from 2 to 25 wt. % of said composition.

13. A process for preparing a one- or two-component adhesive/sealant composition according to claim 1, comprising the following process steps:
a) dispersing the non-functional thermoplastic polymer in pulverulent form in the dissolving agent;
b) dissolving the non-functional thermoplastic polymer until homogeneity is achieved and a polymer solution is formed;
c) cooling the polymer solution;
d) dispersing the polymer solution with at least one reactive binder and carbon black to form the one- or two-component adhesive/sealant composition.

14. A process according to claim 13, wherein in steps a) and b) the ratio of non-functional thermoplastic polymer to dissolving agent is 2:1 to 1:50.

15. A process according to claim 13, wherein in steps a) and b) the ratio of non-functional thermoplastic polymer to dissolving agent is 2:1 to 1:5.

16. A process according to claim 13, wherein step d) is carried out in a dry atmosphere.

17. A one- or two-component adhesive/sealant composition made by the process of claim 13.

18. A method for gluing a glass windscreen in a vehicle, comprising using a one- or two-component reactive adhesive/sealant composition according to claim 1 to join said glass windshield to said vehicle.

19. A one- or two-component reactive adhesive/sealant composition comprising a reactive binder comprising a prepolymer with reactive isocyanate groups or reactive silane groups selected from the group consisting of alkoxysilanes, acetoxysilanes, silazanes, oximatosilanes, and combinations thereof, 15 to 25 wt. % of the total composition of carbon black as a reinforcing filler and a solution of at least one non-functional thermoplastic polymer selected from the group consisting of vinyl chloride homo- and copolymers, ethylene-vinyl acetate copolymers, (meth)acrylic acid ester homo- and copolymers, atactic and isotactic poly-α-olefins, polycarbonates, polyesters, phenolic resins, styrene homo- and copolymers and mixtures thereof in at least one high-boiling dissolving agent selected from the group consisting of ethyl acetate, isoparaffins, dialkyl phthalates, dialkyl adipates, dialkyl sebacates, alkyl, aryl and alkyl aryl phosphates, alkylsulfonic acid phenyl esters, mineral oil and mixtures thereof, wherein the ratio of non-functional thermoplastic polymer to high-boiling dissolving agent is from 2:1 to 1:50.

20. A method for increasing the electrical resistance of a one-or two-component adhesive/sealant comprised of a reactive binder and more than 10 wt. % of the total composition of carbon black as a reinforcing filler, said method comprising a step of combining said one- or two-component composition with a solution of at least one non-functional thermoplastic polymer in at least one dissolving agent.
